(19) United States
(12) Patent Application Publication
(10) Pub. No.: US 2006/0013075 A1
(43) Pub. Date: Jan. 19, 2006

(54) InfantClock

(76) Inventor: James Clarence Johnson, Conyers, GA (US)

Correspondence Address: James C. Johnson, 575 Clubland Circle, Conyers, GA, 30094, US

(21) Appl. No.: 10/710,466

(22) Filed: Jul. 13, 2004

(51) Int. Cl. G04B 19/06

(52) U.S. Cl. 368/228

(57) ABSTRACT

A device having the appearance of a conventional clock intended to be used by new parents. The device may be used as a decoration for the infants' room. In a preferred embodiment the device has the conventional numerals from 1 to 12, but is marked predominately to indicate weeks instead of hours. The device is also useful as a photographic aid in order to date photographs and movies that the new parents make in the early stages of child development.

### BACKGROUND OF INVENTION

Although the device of this invention may be thought of as simply a novelty or decoration, it has as a basis the need for time dating of materials related to the early days, weeks and months of infants. It has long been the practice of professional photographers to use props in order to establish the age of a child at the time a particular picture was taken. An example would be the use of a large numeral 1 used in a photograph to indicate that the child was one year old at the time of the photograph. Including a cake with one candle in a picture would, of course, be another way of establishing the age when a photograph was taken.

With the technology development of recent years, video recorders and digital cameras are available and are commonly used in most households. This is, in fact, particularly true of households having infants and small children. There is a need, then, for a device which can be used in this household environment which would easily and effortlessly indicate time associated with child development. It should be noted that during the first days and weeks of an infants life changes are taking place rapidly. It is this time that is the most hectic for parents as well. For this reason, it is important that photographs taken during this time be documented and related to the baby's age. The device of this present invention provides a convenient and practical means to record age while also providing a novelty or decoration for the nursery.

### DETAILED DESCRIPTION

The invention is a device having the appearance of a conventional clock typically with the numerals 1 to 12 arranged in a circle and “hands” indicating hours and minutes. The appearance would be such as to be recognizable as a common time keeping device. In one embodiment of the present invention the clock, or simulated clock, would have the common clock markings but would have the word “weeks” as a predominate marking.

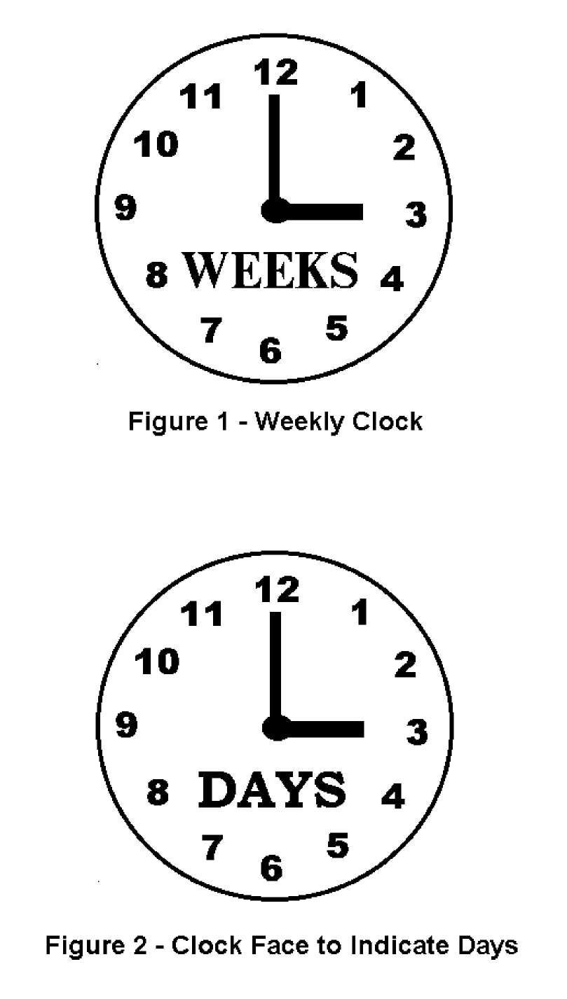

The device would provide a means to change the pointers or “hands” so that different weeks could be indicated. As an example, if the long hand were toward the 12 while the short hand was toward the 3, it would be obvious that a 3 week time period was indicated. This example is shown by FIG. 1.

Such a device serves as a novelty or decoration for a baby's nursery but also functions to time stamp photographs taken during the first weeks and months of the child's rapid development. This clock-like device would be placed near the infant while the picture is taken. When video equipment is used the user would simply pan the room to focus on the clock which would be on the wall or an appropriate stand. In this way photographs taken in the early stages of child development could easily be documented with the appropriate time or age of the child. It will be well understood by new parents that such a convenience would be most welcomed during these hectic first days and weeks.

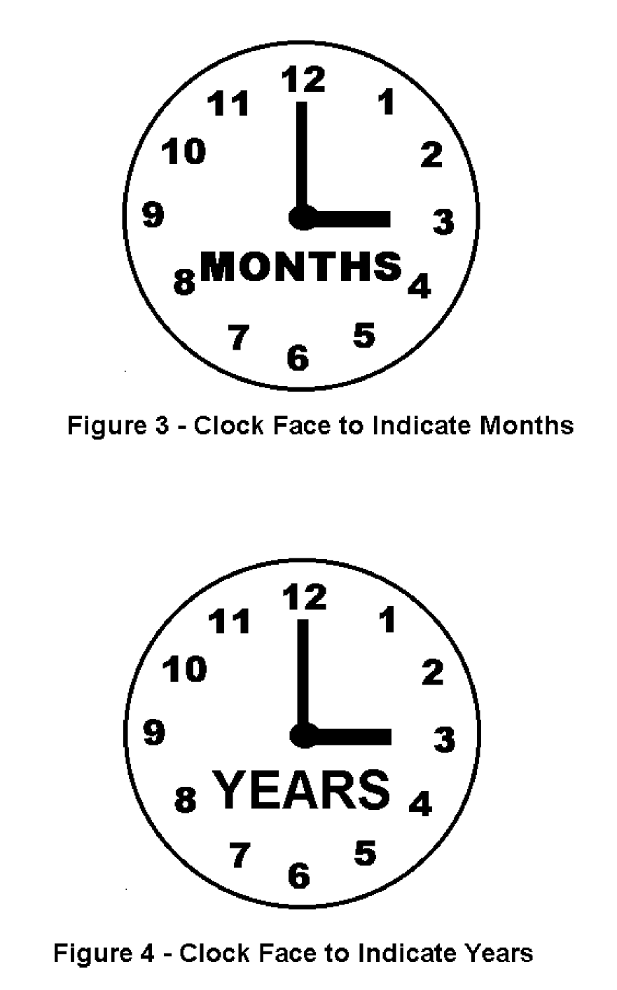

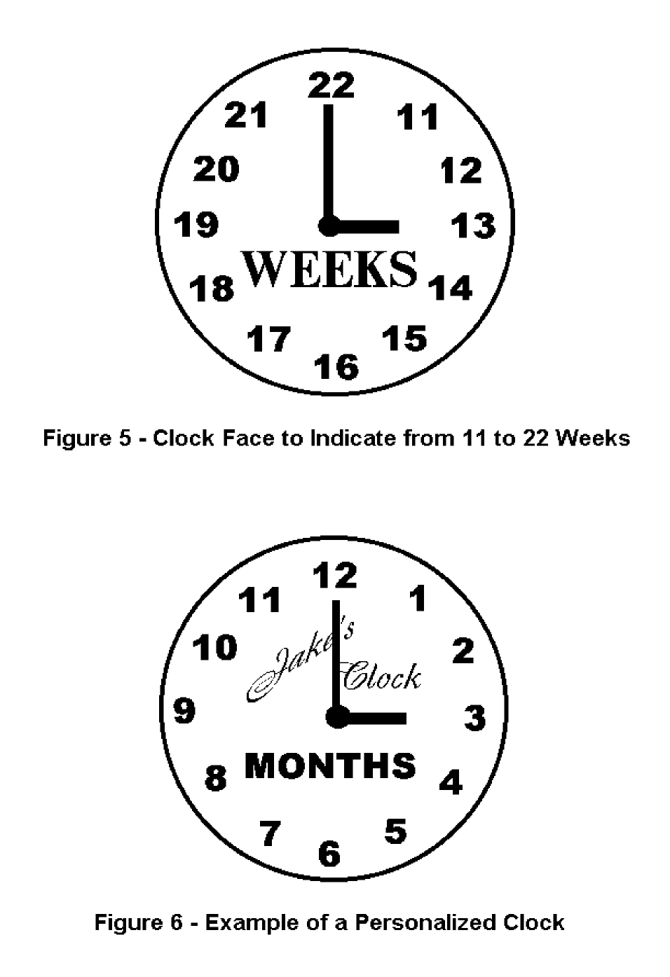

It is envisioned that the device might be provided with interchangeable faces which could be changed as the child grows. For example, a face indicating days such as that shown by FIG. 2 would be changeable to one indicating the first 12 weeks as was shown in FIG. 1. A version could be made showing weeks 11 through 22 such as that shown by FIG. 5. This could then be followed by a face to indicate months as shown in FIG. 3. It may even be desired to continue using such a device to indicate the first years (FIG. 4). The clock face could be simply changed by temporarily removing the clock hands and any protective cover.

It is also envisioned that the device would be designed to be pink in color for use by the parents of a girl while the color scheme would be predominately blue when intended for use in a boy's room.

In a particular embodiment of the invention a working second hand is included to add realism and perhaps even the ticking noise. In general, the device would be manually advanced either directly or by a knob located on the back. It is, of course, possible to provide actual working mechanisms to advance the clock but these mechanisms, when provided, would increase cost.

Other embellishments are possible without departing from the spirit of the invention. In order to keep cost low a plastic version is expected to be most common. However, when used as a keepsake a brass or other refinement might be used. Personalized versions can be made such as those shown by the drawing of FIG. 6.

I claim:

1. A device having the appearance of a clock, comprising: numerals placed in a pattern and hands or pointing devices arranged to mimic a conventional clock, having both long and short hands; means provided for changing the position or appearance of position of the pointing devices; and the word WEEKS predominately displayed.

2. The device of claim 1 further comprising a moving second hand to mimic normal clock operation.

3. The device of claim 2 wherein the second hand movement is accompanied by a ticking noise to simulate true clock operation.

4. The device of claim 1 wherein a blue color is used to associate the device with a male infant or a pink color is used to associate the device with a female infant.

5. The device of claim 4 further comprising a moving second hand to mimic normal clock operation.

6. The device of claim 5 wherein the second hand movement is accompanied by a ticking noise to simulate true clock operation.

7. A device having the appearance of a clock, comprising: numerals placed in a pattern and hands or pointing devices arranged to mimic a conventional clock, having both long and short hands; means provided for changing the position or appearance of position of the pointing devices; and the word DAYS predominately displayed.

8. The device of claim 7 further comprising a moving second hand to mimic normal clock operation.

9. The device of claim 8 wherein the second hand movement is accompanied by a ticking noise to simulate true clock operation.

10. The device of claim 7 wherein a blue color is used to associate the device with a male infant or a pink color is used to associate the device with a female infant.

11. The device of claim 10 further comprising a moving second hand to mimic normal clock operation.

12. The device of claim 11 wherein the second hand movement is accompanied by a ticking noise to simulate true clock operation.

13. A device having the appearance of a clock, comprising: numerals placed in a pattern and hands or pointing devices arranged to mimic a conventional clock, having both long and short hands; means provided for changing the position or appearance of position of the pointing devices; and the word MONTHS predominately displayed.

14. The device of claim 13 further comprising a moving second hand to mimic normal clock operation.

15. The device of claim 14 wherein the second hand movement is accompanied by a ticking noise to simulate true clock operation.

16. The device of claim 13 wherein a blue color is used to associate the device with a male infant or a pink color is used to associate the device with a female infant.

17. The device of claim 16 further comprising a moving second hand to mimic normal clock operation.

18. The device of claim 17 wherein the second hand movement is accompanied by a ticking noise to simulate true clock operation.
